(19) United States
(12) Patent Application Publication
(10) Pub. No.: US 2023/0195603 A1
(43) Pub. Date: Jun. 22, 2023

(54) APPLICATION HEALTH MONITORING AND REPORTING SYSTEM

(71) Applicant: BCE Inc., Verdun (CA)

(72) Inventors: Jin Kang, Mississauga (CA); Guang Lu, Mississauga (CA); Chuan kevin Li, Mississauga (CA); Xiaopeng Fan, Mississauga (CA); Ismaeel Ahmad Ali, Mississauga (CA); Hitendrasinh Mahida, Mississauga (CA); Manpreet Bhinder, Mississauga (CA)

(21) Appl. No.: 18/084,668

(22) Filed: Dec. 20, 2022

Related U.S. Application Data
(60) Provisional application No. 63/291,561, filed on Dec. 20, 2021.

(51) Int. Cl. G06F 11/36

(52) U.S. Cl. CPC G06F 11/3664

(57) ABSTRACT

An application health monitoring and reporting system is disclosed herein that allows managers of an application to have real-time visibility to the health of the application and which reports any issues associated with the application. The system is able to identify the issue(s) of why a particular service or micro-services, an icon, a picture or image or any item that is presented on a webpage as part of the application, as well as the failure, status of the failure, estimated time for resolving the failure, along with a hyperlink to view the full details of the failure which contains a summary of the overall health of the services. This system may help to monitor and report the issues in the production of applications, networks, underlying hardware/software components, and any other components.

### CROSS REFERENCE TO RELATED APPLICATIONS

This application claims priority to U.S. Provisional Patent Application No. 63/291,561, the entire contents of which is incorporated by reference herein for all purposes.

### TECHNICAL FIELD

The present disclosure relates to application health monitoring and reporting, and in particular to determining statuses for components of the application.

### BACKGROUND

An application often comprises several components that co-operatively function to provide the overall application functionality. The components may comprise various hardware, software, service, and/or micro-service components which may be dispersed throughout a network.

As a simplified example, an application may be developed and presented to end-users on a webpage. When an end-user accesses the webpage to interface with the application, several of the application components may be triggered to present the webpage. For example, when the end-user accesses the webpage the application may make a request for content to be displayed and a request for an advertisement to be displayed. The content and advertisement to be displayed on the webpage may be stored at different servers or other hardware components. Each of the hardware components may also have software components running thereon providing instructions to select, retrieve, and transmit the requested content and/or advertisement.

While the above is a simplified example, it would be well appreciated that applications are often much more complex, requesting and aggregating data/inputs from various components, which may in turn make requests to various other components. It may be difficult to identify issues with a particular aspect of an application. It may also be difficult to identify a component that has caused the issues with the particular aspect of the application.

Systems and methods that enable additional, alternative, and/or improved application health monitoring and reporting remain highly desirable.

### SUMMARY

A method of health monitoring for an application is disclosed, comprising: receiving component data from a plurality of components associated with the application; retrieving, from a database, a component dependency list indicative of dependencies of the plurality of components associated with the application; determining a component status for each of the plurality of components in the component dependency list based on the received component data; and generating an application status notification indicating the determined component statuses for one or more of the of the plurality of components in the component dependency list.

The above-described method may further comprise: transmitting the application status notification to an application manager through a portal.

The above-described method may further comprise: receiving subscription parameters from the application manager through the portal, the subscription parameters indicating one or more application events that the application manager has subscribed to; and transmitting the application status notification to the application manager when the determined component statuses correspond to an application event of the one or more application events that the application manager has subscribed to.

The above-described method may further comprise: transmitting the application status notification to a user of the application through the application.

In the above-described method, the application status notification may comprise information allowing the user of the application to take a corrective action.

In the above-described method, the application status notification may indicate a failed component of the plurality of components in the component dependency list, and the application status notification may further indicate an estimated time to fix the failed component.

In the above-described method, each component of the plurality of components may comprise a unique identifier that is used to identify the respective component.

In the above-described method, the component data may be received as log data from the plurality of components, each log comprising the unique identifier for the respective component.

The above-described method may further comprise: determining the component status from the component data based on whether a component state of the component has changed.

The above-described method may further comprise: performing testing of one or more of the plurality of components.

The above-described method may further comprise: applying pre-defined rules to the component data, wherein a component status is determined to have failed if a rule has been violated.

The above-described method may further comprise: transmitting the application status notification if a rule has been violated.

The above-described method may further comprise: retrieving a KPI for the component data; and determining that an anomaly has occurred based on the KPI when the component data did not violate a rule, wherein the component status may be determined based on the anomaly.

In the above-described method, the component dependency list may be defined manually by an application manager.

The above-described method may further comprise: determining, from the received component data, the plurality of components associated with the application and their dependencies; generating, based on the determined dependencies, the component dependency list; and storing the component dependency list.

In the above-described method, the plurality of components may comprise any one or more of: hardware components, software components, service components, and micro-service components.

A system for health monitoring for an application is also disclosed, comprising: a processor; and a memory operably coupled with the processor, the memory having computer-executable instructions stored thereon, which when executed by the processor configure the processor to: receive component data from a plurality of components associated with the application; retrieve, from a database, a component dependency list indicative of dependencies of the plurality of components associated with the application; determine a component status for each of the plurality of components in the component dependency list based on the received component data; and generate an application status notification indicating the determined component statuses for one or more of the of the plurality of components in the component dependency list.

A non-transitory computer-readable medium having computer-executable instructions stored thereon is further disclosed, which when executed by a computer configure the computer to perform a method comprising: receiving component data from a plurality of components associated with the application; retrieving, from a database, a component dependency list indicative of dependencies of the plurality of components associated with the application; determining a component status for each of the plurality of components in the component dependency list based on the received component data; and generating an application status notification indicating the determined component statuses for one or more of the of the plurality of components in the component dependency list.

### BRIEF DESCRIPTION OF THE DRAWINGS

Further features and advantages of the present disclosure will become apparent from the following detailed description, taken in combination with the appended drawings, in which:

FIG. 1 shows a representation of the application health monitoring and reporting system in accordance with an aspect of this disclosure;

FIG. 2 shows a representation of a component dependency list for a plurality of components associated with an application;

FIG. 3 shows a functional diagram of the application health monitoring and reporting system;

FIG. 4 depicts a logging sequence diagram;

FIG. 5 depicts a logging configuration server call flow;

FIG. 6 depicts a logging server call flow;

FIG. 7 depicts a subscription sequence diagram;

FIG. 8 depicts a subscription configuration server call flow;

FIG. 9 depicts a subscription parsing server call flow;

FIG. 10 depicts a monitoring sequence diagram;

FIG. 11 depicts a monitoring configuration server call flow;

FIG. 12 depicts a monitoring server call flow;

FIG. 13 depicts a schematic diagram of analytics functionality;

FIG. 14 depicts an analytics configuration server call flow;

FIG. 15 depicts a rules server call flow;

FIG. 16 depicts an aggregator call flow;

FIG. 17 depicts a machine learning call flow;

FIG. 18 depicts a reporting sequence diagram;

FIG. 19 depicts a reporting call flow;

FIG. 20 depicts a dashboard sequence diagram;

FIG. 21 depicts a dashboard application server call flow; and

FIG. 22 depicts a method performed by the application health monitoring and reporting system.

It will be noted that throughout the appended drawings, like features are identified by like reference numerals.

### DETAILED DESCRIPTION

An application health monitoring and reporting system is disclosed herein that allows managers of an application to have real-time visibility to the health of the application and which reports any issues associated with the application. The application health monitoring and reporting system is not limited to strictly provide a list of all the components and its health status. The system is able to identify the issue(s) of why a particular service or micro-services, an icon, a picture or image or any item that is presented on a webpage or user interface as part of the application, as well as the failure, status of the failure, estimated time for resolving the failure, along with a hyperlink to view the full details of the failure which contains a summary of the overall health of the services. This system may help to monitor and report the issues in the production of applications, networks, underlying hardware/software components, and any other components.

The application health monitoring and reporting system may receive log data from the components associated with the application. The application health monitoring and reporting system may further carry-out monitoring tests of the application components. Based on the monitoring test results as well as the log data, the application health monitoring and reporting system may perform complex analytics of the component data. The component data may be evaluated against rules to determine the status of the components and identify any issues. The application health monitoring and reporting system may further implement machine learning to identify component anomalies that did not violate any of the rules, but which may result in a notification to the application manager.

The application health monitoring and reporting system may further be able to identify and define dependencies of components associated with the application being monitored. Therefore, in addition to being able to identify issues/failures of various components associated with the application, the application health monitoring and reporting system may be able to identify root causes of the issues.

Insights determined by the application health monitoring and reporting system can be meaningfully presented to managers of the application, such as development teams, etc. The application health monitoring and reporting system may further be provided with user-friendly functionality to enhance user experience.

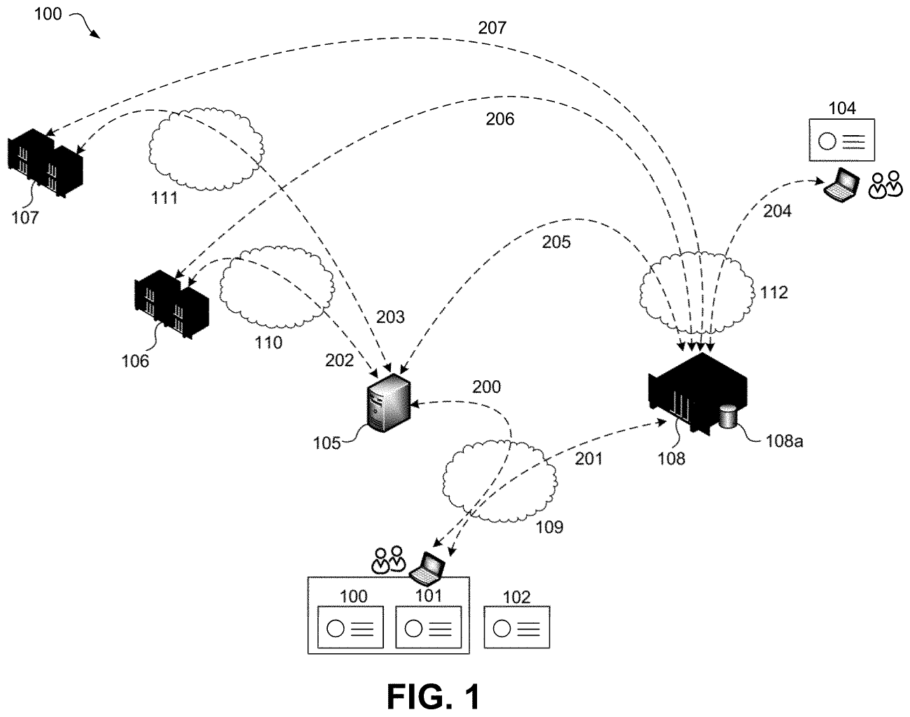

Embodiments are described below, by way of example only, with reference to FIGS. 1-22.

FIG. 1 shows a representation of the application health monitoring and reporting system in accordance with an aspect of this disclosure. The application health monitoring and reporting system 100 comprises a health monitoring server 108 with an associated database 108a for monitoring and reporting the health of applications as will be further described herein. The health monitoring server 108 may be configured to interface with all aspects of an application, such as end-users of the application 100, 101, managers of the application 104, front-end application server 105, internal and external back-end application servers 106 and 107, etc.

The front-end application server 105 may aggregate application components and present the application to end-users 101 via a user interface. The end-users may access the application via a webpage or other platform/interface, for example webpage 100, 101, over application cloud 109. The front-end application server 105 may also provide an overall real-time service page, such as a micro-service status page 102. The typical application flow involves a user triggered request, such as a web browser launch, or a server pushed service, such as an alert event.

In a user-triggered scenario, when an end-user launches the services through application UI (100 and 101 with component P&Q), the client may submit a request to the front-end application server 105 via API call 200. Front-end application server 105 starts processing the request and may retrieve the application data from internal data source 106 via API call 202 over an internal application cloud 110. In parallel, front-end application server 105 starts processing the request and may retrieve the application data from external data source 107 via API call 203 over an external application cloud 111. The internal and external data sources 106 and 107 may also be referred to herein as internal and external back-end application servers 106 and 107. The internal and external data sources 106 and 107 may be used to provide specific services and application-based user interfaces for the application.

In a server-pushed scenario, when front-end application server 105 has an event that it needs to push to the client, the front-end application server 105 may retrieve the application data from internal data source 106 via API call 202 over internal application cloud 110. In parallel, front-end application server 105 may retrieve the application data from external data source 107 via API call 203 over external application cloud 111 if necessary. Once application server 105 has all data available, it will push the services to the client end-user (100 and 101 with component P&Q) via API call 200.

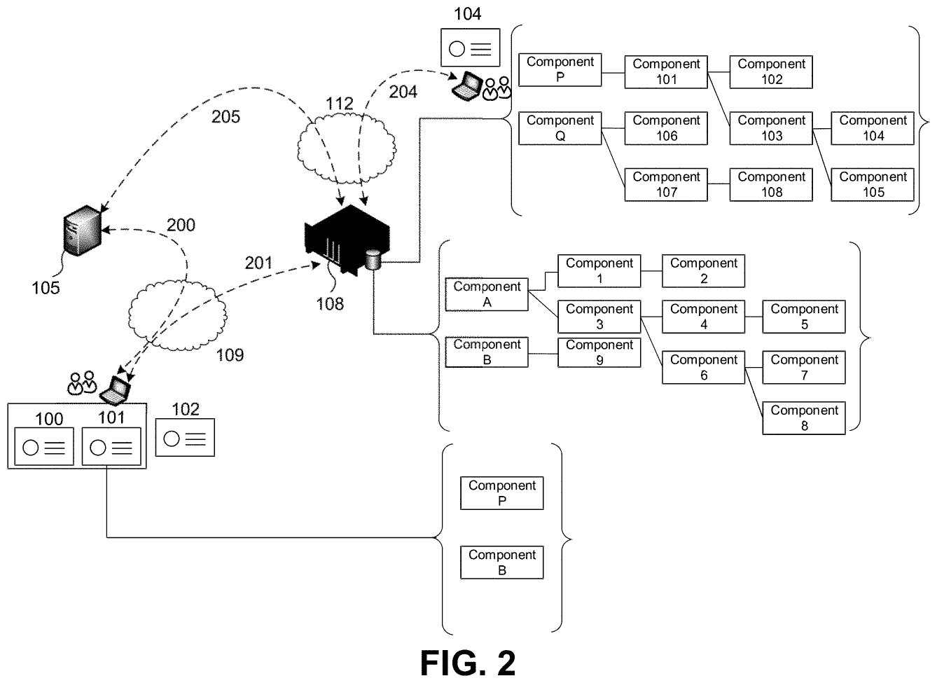

The health monitoring server 108 and associated database 108a may comprise an inventory of components associated with an application, as well as a hierarchy and status of each component of the application, including hardware, software, services, micro-services, etc. The dependencies can identify a hierarchy and dependency of hardware, software, sensors, API, third party API, etc. The health monitoring server 108 can maintain a complete inventory of each component of a monitored application along with its dependencies. Each component may be assigned with a unique ID automatically by the application, which may help to figure out what components are or will be affected if any of the dependencies go down. Also, as will be further described with reference to FIG. 2, the health monitoring server 108 may define a dependency tree which may allow the dependents of a respective node to be notified about the node's status or condition. The health monitoring server 108 may comprise a software module that provides computer-executable instructions, which when executed by a processor of the server, configures the health monitoring server 108 to perform the above-described functionality related to inventory of components and determining the component dependencies and hierarchies.

The health monitoring server 108 may further monitor and store the health of all components of the application listed in the inventory. The health monitoring server 108 may also be configured as to when, what, and how the status of any component is checked/determined. The configuration of the health monitoring server 108 may be performed by the application manager 104, as will be further described herein. Once the health monitoring server 108 detects a failure associated with any component of the application, the status of that component may be updated. The health monitoring server 108 may also update status(es) of all other components that depend upon the failed component. The health monitoring server may generate an application status notification using the component dependency list with the component statuses indicated therein.

Monitored testing by the health monitoring server may be scheduled, on demand, or automatically triggered by the detection of a failed component. Upon detection of a failed component, a test may be performed on the parent component that receives input from the failed component, as defined by the component dependency list. Testing may comprise SNMP, Pinging, Rest API calls, PingPong. The instructions for configuring the health monitoring server 108 to perform the above-described functionality related to monitoring the health of various application components may be provided as computer-executable instructions and stored in a memory associated with a processor of the server.

As further descried herein, the status of any component may be derived from status of all its dependencies and also from the component itself and used to generate an application status notification. If one component has failed, then all of its dependent components may be retested to verify failures. The end-user that accesses the application may also be able to view an application status notification or a part thereof. The application status notification may be displayed at end-user UI 100 or 101, or status page 102. Providing the application status notification to the end-user may allow the end-user to see issues associated with the application and possibly take corrective action to resolve the failed component where possible.

As noted above, the health monitoring server 108 may be configured to interface with all aspects of an application, such as end-users of the application 100, 101, application managers 104, front-end application server 105, internal and external back-end application servers 106 and 107, etc. Accordingly, the health monitoring server 108 may receive component data from these various components that are used to provide the application.

For example, the health monitoring server 108 may exchange information and receive component data from the end-users 100, 101 using API call 201 over application cloud 201. The health monitoring server 108 may exchange information and receive component data from the front-end server 105 using API call 205 over network cloud 112. The health monitoring server 108 may exchange information and receive component data from the internal back-end server 106 via API call 206 over network cloud 112. The health monitoring server 108 may exchange information and receive component data from the external back-end server 107 via API call 207 over network cloud 112. The health monitoring server 108 may further exchange information service provider's management user 104 via API call 204 over network cloud 112.

For example, the application manager 104 may request application status notifications from the health monitoring server 108, as will be further described herein. The health monitoring server 108 may transmit application status notifications and push notifications to the application manager 104, as will also be further described herein. The application manager 104 may interface with the health monitoring server 108 through a webpage/portal, and may have the ability to conduct administrator services such as updating health information from third parties, administering and monitoring the associated health monitoring database 108a and it's dependencies, conduct performance analysis, update components, send or trigger updates to end-users, front and back-end application servers, etc. For example, developing team members of the application may be able to view and manage all notifications/alerts health monitoring server 108. The application manager 104 may facilitate with assign the tickets to other members for investigation. The developing team members may be able to investigate and update the status of failed components along with along with an estimated time required to fix the failed component(s). Additionally, the status of any component may be received from external systems and provided to the health monitoring server 108 for analysis. In one example, the status of any component may be determined from an external system and provided to the monitoring server 108 to update the component status and estimated time required to fix the failed component.

The application manager 104 may also allow authorized stakeholders to subscribe to the application status notifications. The subscribers may receive the application status notification from the application server 108 through push notifications, emails, slack, pagers, or other similar means.

The front- and back-end application servers 106 and 107 may be used to provide health information to the health monitoring server 108 on a continuous basis using API calls 206 and 207 to update the database. Internally, the front- and back-end application servers 106 and 107 may create logs/KPIs or any other mechanism to track the behaviour and health of the application and servers, as will be further described herein.

The health monitoring server 108 may be capable of communicating in a Sub/Pub real-time updates to the front and back-end application servers 106 and 107 of any changes received from the service provider administrator or any changes it has detected using API calls.

The front-end application server 105 may provide a role-based user interface as well as REST API interface to provide status of each component associated with an application. The user interface may be generated/provided to the customer in one or both of an end user role and an administrator role. For example, the end user role may provide an interface which simplifies the issues and translates into a customer friendly language. For example, the end user may be presented with a dashboard that is “green” or “red”, and a simple description in the broad category such as “Network Issues, Fiber Cut, System Failure or Unknown still under investigation, and the ETA when the resolution will be in place. Additionally or alternatively, if the end user would like to know more technical details, as may be configured in the user's profile settings, the interface may be provided to allow the end user to have more technical information, similar to what administrator would see. The more technical information may include, for example, HTTP error code, SNMP alarms, etc.

While the servers within the application health monitoring and reporting system 100 depicted in FIG. 1 are shown as being respective physical servers, it is noted that all servers can be a virtualized function deployed as SaaS, PaaS, IaaS model and do not necessarily have to be implemented as on-premise hardware, as would be appreciated by a person skilled in the art.

FIG. 2 shows a representation of a component dependency list for a plurality of components associated with an application. As shown in FIG. 2, the health monitoring server 108 may store in its associated database a component dependency list for all of the components associated with an application. The component dependency list may be used to represent a hierarchy and status of all of the components associated with the application, such as each hardware/software component, services, micro-services, etc.

Each component may be assigned with a unique ID automatically by the application, which may help to figure out what components are or will be affected if any of the dependencies go down. The inventory of application components and their dependencies may be defined manually beforehand. Alternatively, the health monitoring server 108 may comprise or be associated with a discovery agent that is configured to auto detect the application component dependencies and hierarchies from component data.

As depicted in FIG. 2, the end-user may be provided with application functionality as indicated by Component P and Component B. The health monitoring server 108 may have stored within its associated database a dependency list indicating the dependencies of Components B and P. As will be further described herein, this may allow the health monitoring server 108 to precisely identify root causes of application component issues/failures, which may help to facilitate faster resolutions of the failed components. For example, the end-user 100, 101 may access an application through a webpage and find that component P has failed, perhaps because this application functionality is not available to the end-user of the application when it otherwise should be. The health monitoring server 108 may determine in a manner that is further described herein that component P is down because component 105 is down, which subsequently affects the components 103 and 101 that component P depends on.

The dependency tree may further comprise dependencies for other components, such as components A and Q, which are not accessed by the end-user 100, 101 of the application.

In some embodiments, an application health notification may be generated and presented to application manager 104 as the component dependency list, with functioning components coloured green and failed components coloured red, to present a readily-understandable and user-friendly visualization of the application health.

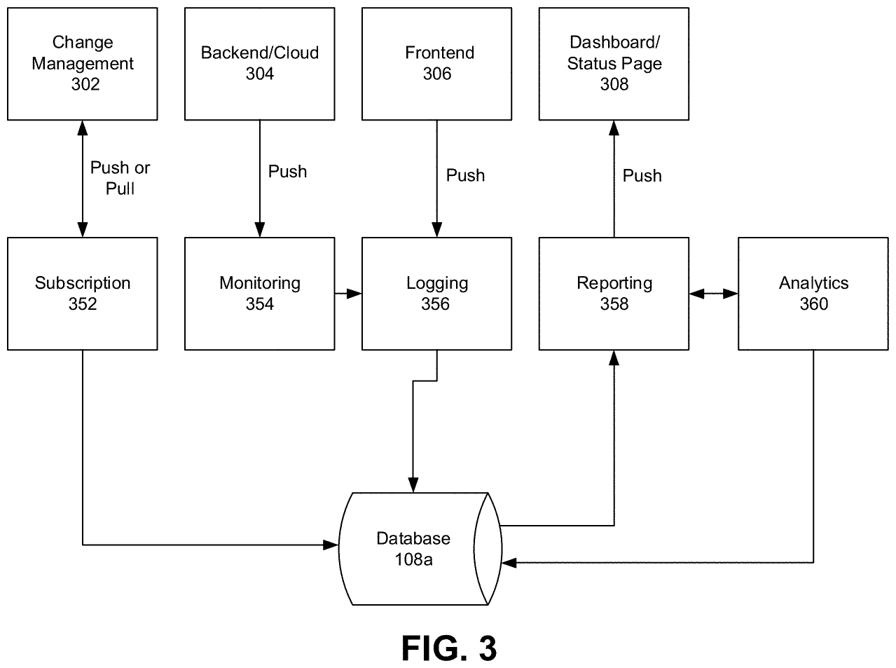

FIG. 3 shows a functional diagram of the application health monitoring and reporting system. The health monitoring server 108 may comprise several functional modules, such as subscription module 352, monitoring module 354, logging module 356, reporting module 358, and analytics module 360. These modules may be stored as computer-executable instructions at the health monitoring server 108. As depicted in FIG. 3, the subscription module 352, logging module 356, reporting module 358, and analytics module 360, may interact with the health monitoring server's associated database 108a.

The subscription module 352, monitoring module 354, logging module 356, and reporting module 358 may also respectively interact with various external input sources, such as a change management module 302, backend/cloud module 304, frontend module 306, and dashboard/status page module 308.

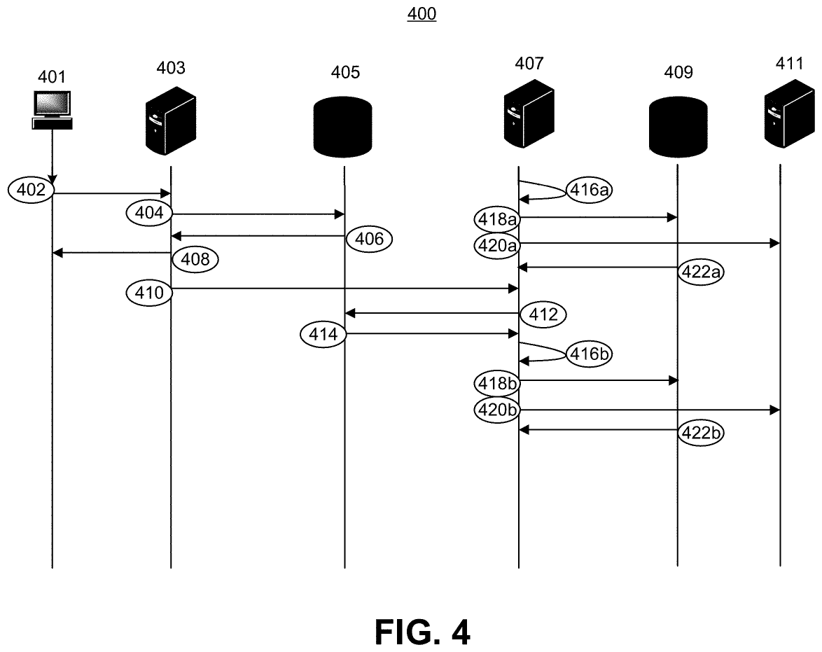

Functionality provided by the subscription module 352, monitoring module 354, logging module 356, reporting module 358, and analytics module 360, as well as their interactions with the change management module 302, backend/cloud module 304, frontend module 306, and dashboard/status page module 308, will be further described with reference to FIGS. 4 thru 21.

FIGS. 4 thru 21 depict various sequence diagrams and call flows that exemplify the functionality of the health monitoring server 108. Except where otherwise specified, the various servers and databases depicted in FIGS. 4 thru 21 may be implemented as part of the health monitoring server 108 and its associated database 108a.

FIG. 4 depicts a logging sequence diagram (400). A user, such as an application manager 104, may log onto a dashboard/portal with valid credentials from a computer 401. A user may register and configure an application to be monitored so that logs comprising component data is received from the application components (402). A configuration server 403 may receive and store the configuration in a configuration database (404), and confirmation that the configuration was successful may be received at the configuration server 403 (406). The configuration server 403 may indicate configuration success to the application manager at the computer 401 (408).

The configuration server 403 notifies logging server 407 of the configuration change (410). The logging server 407 queries the configuration database 405 for logging configuration (412) and retrieves the logging configuration file (414). Prior to retrieving the logging configuration file, the logging server 407 may have been validating incoming logs of components associated with the application (416a), storing the logs in a logging database 409 (418a), sending the logs to an analytics server 411 (420a), and receive a notification form the logging database 409 that the storage of logs was successful (422a). The configuration file retrieved at (414) may configure the logging server 407 to validate incoming logs of components associated with the application in accordance with the new logging configuration (416b), store the logs in a logging database 409 (418b), send the logs to an analytics server 411 (420b), and receive a notification from the logging database 409 that the storage of logs was successful (422b). If the user registration of the application to be monitored is the first time that the request was made, the logging server 407 may not have been receiving incoming logs pertaining to components of the application and thus steps 416a-422a may be omitted.

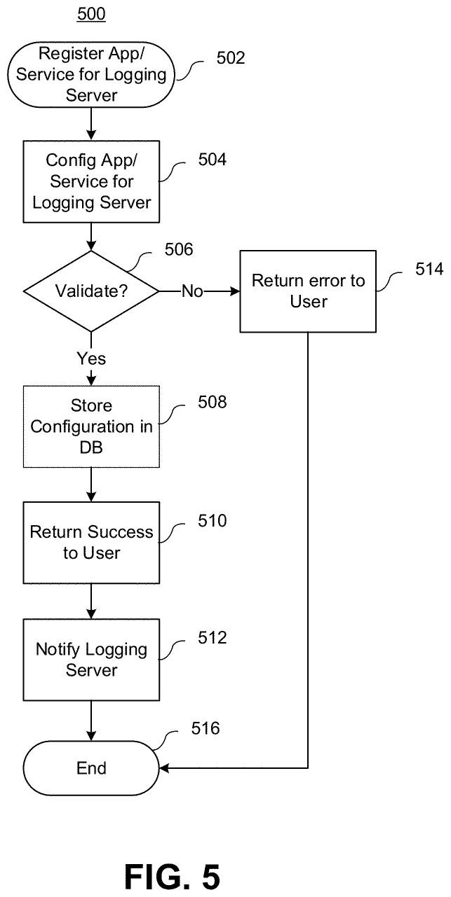

FIG. 5 depicts a logging configuration server call flow (500). The user registers the applications to be logged (502). The registered applications are configured so that the component log data may be received (504). A determination is made if the incoming logging configuration is valid (506). If the logging configuration is determined to be invalid (NO at 506), an error is returned to the user (514), and the method ends (516). If the logging configuration is valid (YES at 506), the configuration server stores the configuration in an associated configuration data base (508). A notification indicating successful storage is sent to the user (510). A notification is sent to the logging server (512) so that component data may be received for the configured application.

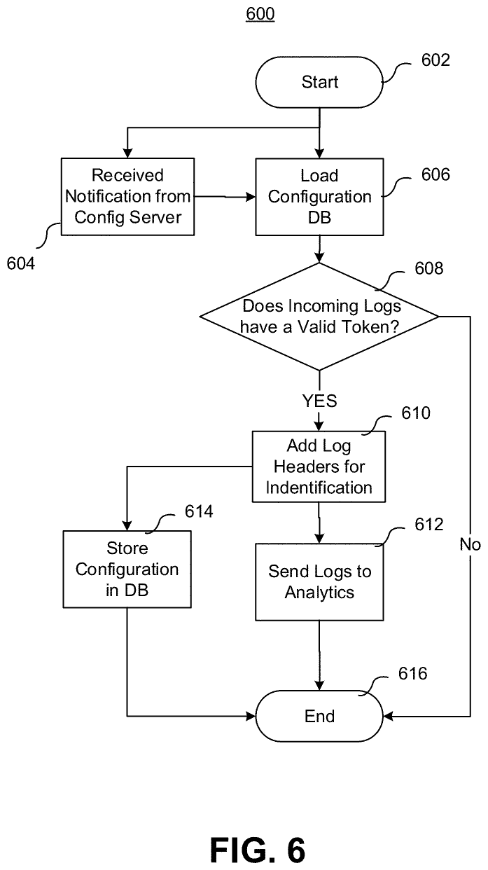

FIG. 6 depicts a logging server call flow (600). The method starts (602) by receiving notification from configuration server (604) of a new logging configuration and/or with loading the logging configuration (606). The logging server may retrieve the logging configuration from the configuration database for loading the logging configuration. A determination is made if the incoming logs have a valid token (608). If the incoming logs have a valid token (YES at 608), a log header is added for identification (610). If the incoming logs have an invalid token (NO at 608), the method ends (616). The logs identified with a header are sent to analytics (612) as well as stored in the logs database (614), and the method ends (616).

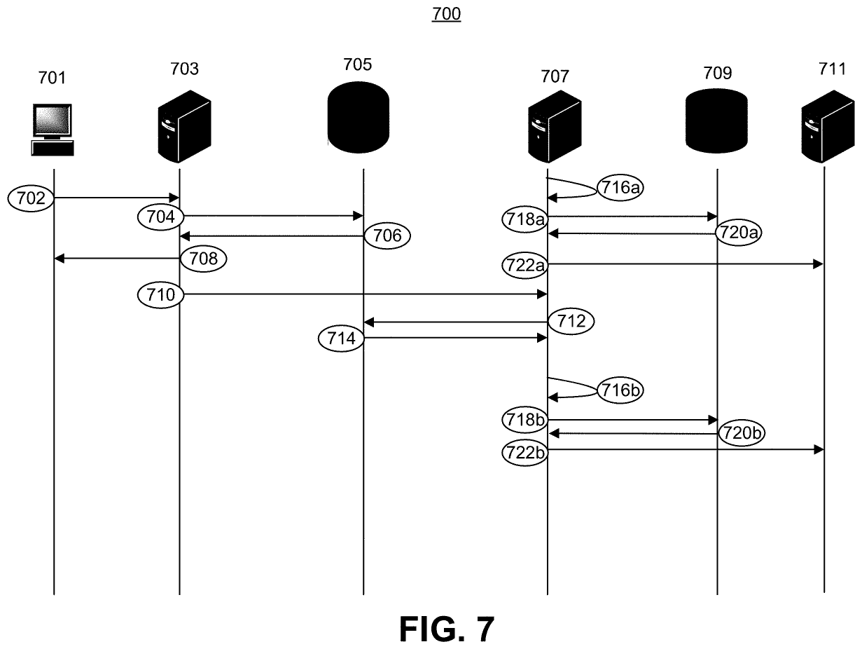

FIG. 7 depicts a subscription sequence diagram (700). A user, such as an application manager 104, may log onto a dashboard/portal with valid credentials from a computer 701. A user may subscribe to certain application events that may be identified during the health monitoring of the application (702). A subscription configuration server 703 may receive and store the subscription configuration in a subscription database 705 (704), and confirmation that the subscription configuration was successful may be received at the subscription configuration server 703 (706). The subscription configuration server 703 may indicate subscription configuration success to the application manager at the computer 701 (708).

The subscription configuration may notify a subscription parsing server 707 of the configuration change (710). The subscription parsing server 707 queries the subscription database for the subscription configuration (712) and retrieves a subscription configuration file comprising subscription parameters that the user has configured for the application (714). Prior to retrieving the subscription configuration file, the subscription parsing server 707 may have been receiving and parsing subscription data in accordance with previous subscription parameters for the application (716a), storing the parsed data in a results database 709 (718a), receive a notification from the results database 709 that the storage of the parsed data was successful (720a), and sending a notification to a notification server 711 when it has been determined that an application event has occurred relating to the application components for which the user has subscribed to (722a). The subscription file retrieved at (714) may provide updated and/or new subscription parameters, which configure the subscription parsing server 707 to receive and parse subscription data in accordance with the updated/new subscription parameters for the application (716b), store the parsed data in the results database 709 (718b), receive a notification from the results database 709 that the storage of the parsed data was successful (720b), and send a notification to a notification server 711 when it has been determined that an application event has occurred relating to the application components for which the user has subscribed to (722b). If the user subscription parameters configured at (702) was the first subscription configuration, the subscription parsing server may not have been previously receiving and parsing subscription data and thus steps 716a-722a may be omitted.

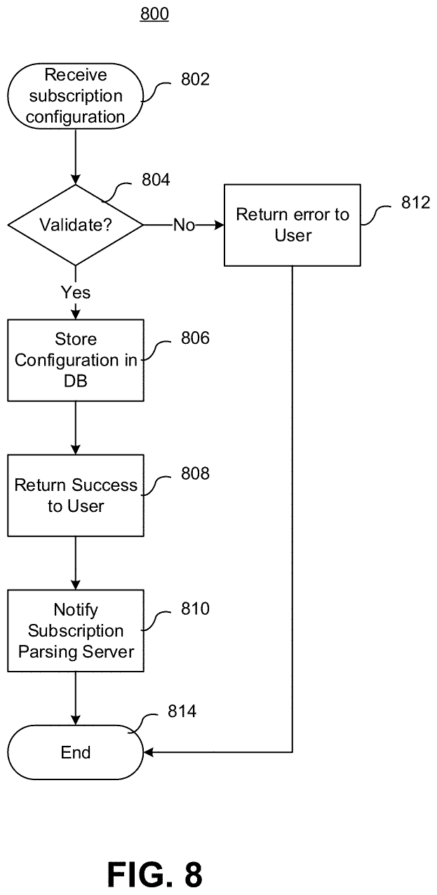

FIG. 8 depicts a subscription configuration server call flow (800). The user registers the applications to be subscribed to for issue notification. The subscription configuration server receives the users requested subscription configuration (802). A determination is made if the subscription configuration is valid (804). If the incoming subscription configuration is valid (YES at 804), the subscription configuration server may store the configuration in an associated subscription data base (806). A notification indicating successful storage of the subscription configuration is sent to the user (808). A notification is sent to the subscription parsing server if the configuration has been successfully stored (810), and the method ends (814). If the subscription configuration is determined to be invalid (NO at 804), an error is returned to the user (812), and the method ends (814).

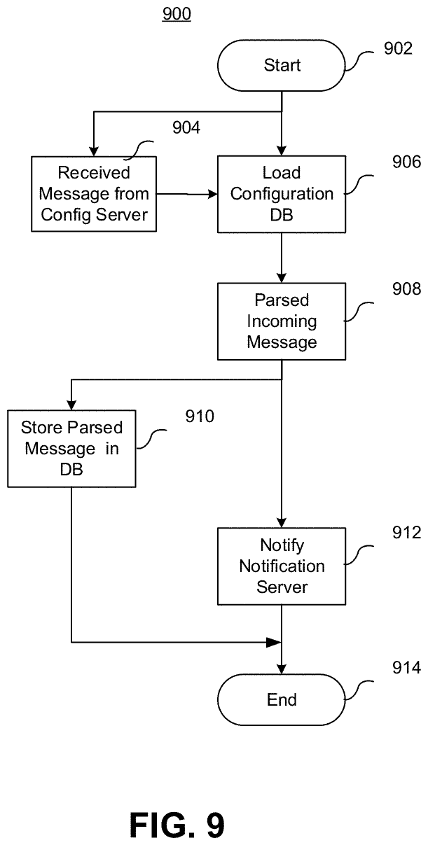

FIG. 9 depicts a subscription parsing server call flow (900). The method starts (902) by receiving notification from subscription configuration server (904) of a new subscription configuration and/or with loading the subscription configuration from subscription database (906). An incoming parsed message may be received (908). The incoming parsed message received may be stored in an associated results database (910). A notification may be sent to the notification server (912) if there is determined to be an application event that the user has subscribed to. After storing the parsed data and/or notifying the notification server, the method ends (914).

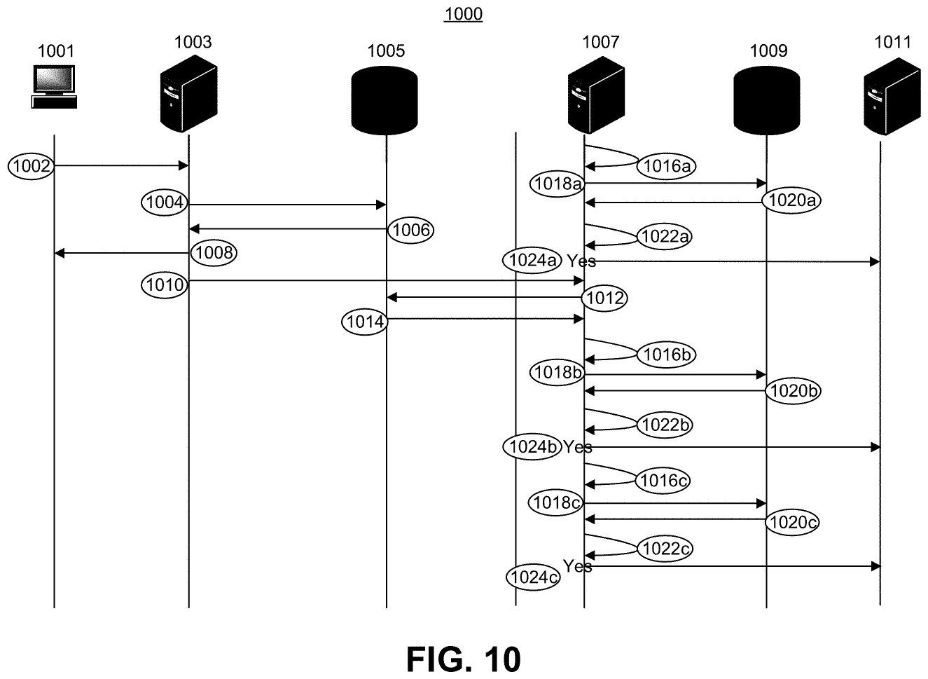

FIG. 10 depicts a monitoring sequence diagram (1000). A user, such as an application manager 104, may log onto a dashboard/portal with valid credentials from a computer 1001. Similar to the logging sequence diagram 400 depicted in FIG. 4, a user may register and configure an application to be monitored (1002). A configuration server 1003 may receive and store the configuration in a configuration database 1005 (1004), and confirmation that the configuration was successful may be received at the configuration server 1003 (1006). The configuration server 1003 may indicate configuration success to the application manager at the computer 1001 (1008). Although the above steps are shown both with reference to the logging sequence diagram 400 and the monitoring sequence diagram 1000, a person skilled in the art will appreciate that these steps may only need to be performed once in order to configure the application for logging and monitoring.

The configuration server 1003 notifies a monitoring server 1007 of the configuration change (1010). The monitoring server 1007 queries the configuration database 1005 for the monitoring configuration (1012) and retrieves the monitoring configuration file (1014). Prior to retrieving the monitoring configuration file, the monitoring server 1007 may have been monitoring components based on received component data and/or by performing component testing (1016a), storing the monitored component data in a results database 1009 (1018a), receiving a notification from the results database 1009 that the storage of the parsed data was successful (1020a), and determining whether a state of the monitored component has changed (1022a). If the state of the monitored component has changed, the monitoring server 1007 may notify the notification server 1011 (1024a).

The monitoring configuration file retrieved at (1014) may provide updated and/or new monitoring configuration parameters, which configure the monitoring server 1007 to monitor application components in accordance with the updated/new monitoring parameters for the application (1016b), store the monitored component data in a results database 1009 (1018b), receive a notification from the results database 1009 that the storage of the parsed data was successful (1020b), and determine whether a state of the monitored component has changed based on the updated/new monitoring parameters (1022b). If the state of the monitored component has changed, the monitoring server 1007 may notify the notification server 1011 (1024b). The above steps may be performed repeatedly (1016c-1024c) until a new monitoring configuration is received.

If the monitoring parameters configured at (1002) was the first configuration received, the monitoring server 1007 may not have been previously monitoring component data and thus steps 1016a-1022a may be omitted.

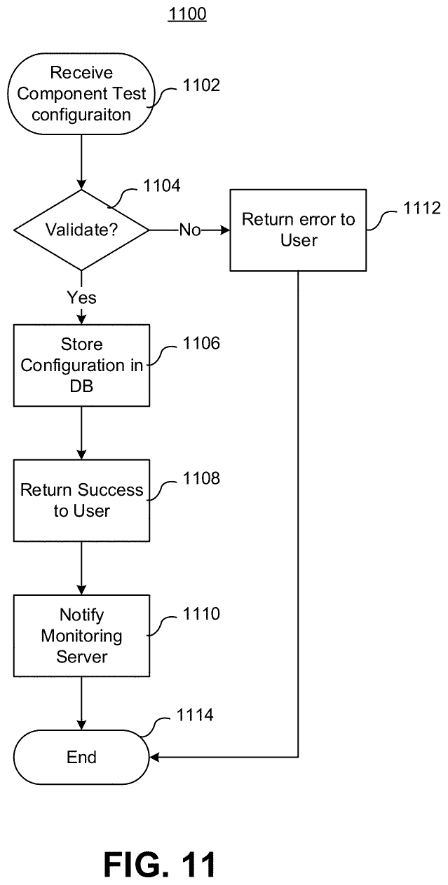

FIG. 11 depicts a monitoring configuration server call flow (1100). The user requests the applications to be monitored and may provide a monitoring test configuration for monitoring components of the application. The configuration server receives the resource test configuration (1102). A determination is made to see if the received resource test configuration is valid (1104). If the received resource test configuration is valid (YES at 1104), the configuration server will store the configuration in an associated configuration database (1106). A notification indicating successful storage of the subscription configuration is sent to the user (1108). A notification of successful storage and of the monitoring configuration parameters is sent to the monitoring server (1110), and the method ends (1114). If the resource test configuration is determined to be invalid (NO at 1104), an error is returned to the user (1112), and the method ends (1114).

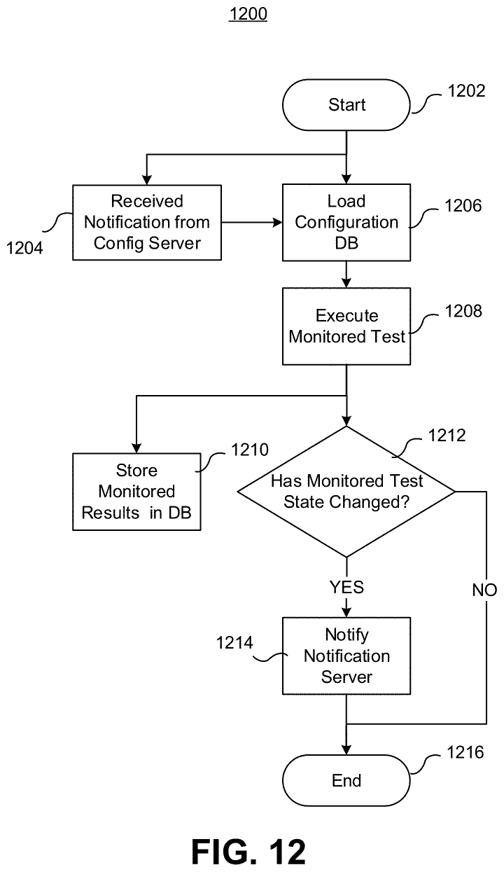

FIG. 12 depicts a monitoring server call flow (1200). The method starts (1202) by receiving a notification from configuration server (1204) of a new monitoring configuration and/or with loading the monitoring configuration (1206). The monitoring server may retrieve the monitoring configuration from the configuration database for loading the monitoring configuration. The monitoring server executes the monitored test (1208), and the monitored results may be stored in an associated results database (1210). That is, when the user has configured new monitoring parameters, the monitoring server may execute the test on the application components. Alternatively or additionally, the monitoring server may be configured to execute the test in at pre-determined time intervals, when a component is detected to have failed, etc., in which case the monitoring server simply loads the monitoring configuration at step 1206.

A determination may also be made if the monitored test state of one or more components associated with the application has changed (1212). If the results from the monitored test differ from a previous test on the same application such that component state has changed (YES at 1212), the monitoring server notifies notification server (1214) and the method ends (1216). If the component state has not changed (NO at 1212), the method ends (1216).

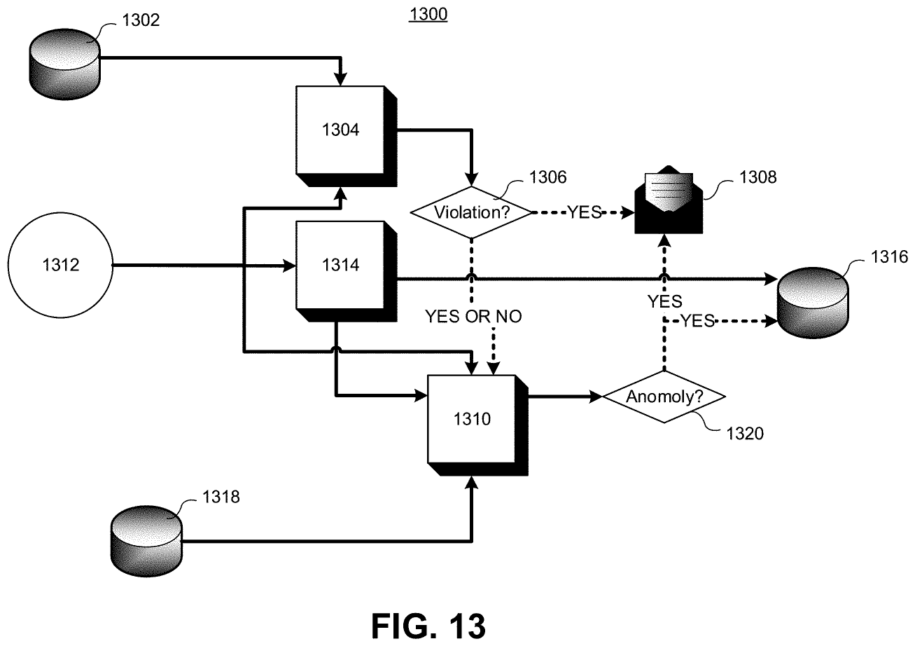

FIG. 13 depicts a schematic diagram of the analytics functionality (1300) of the health monitoring server, corresponding, for example, to analytics module 360 in FIG. 3. An application-rules configuration database 1302 may store and provide the application rules specified by the user to a rule engine 1304. The rule engine may receive component data 1312 including incoming component logs, monitoring test results, and/or other reports, as determined for example from the logging server and/or monitoring server and stored in a results database as has been previously described.

A determination is made based on the rule engine 1304 to assess if the component data violates any of the application rules specified (1306). More particularly, the component statuses for the various components associated with the application may be determined. If the component data violates any of the rules specified, which may for example indicate a component failure, a notification may be sent to the notification engine 1308. The notification engine 1308 may be responsible for generating an application status notification indicating component statuses for the components associated with the application. The application status notification may be generated by identifying one or more components to have failed if the component data has violated a rule defined in the rule engine 1304. The notification engine 1308 may transmit the application status notification to the application manager and possibly to the end-user of the application. Depending on the subscription parameters configured by the application manager, the notification engine 1308 may only transmit the application status notification if a violated rule and/or indication of a failed component corresponds to an application event that the application manager has subscribed to. The output from the rule engine, irrespective of whether a rule has been violated or not, may be sent to a machine learning component 1310.

The component data 1312 may also be sent to an aggregator 1314. The aggregator 1314 may combine the component data. For example, the component data may be combined over pre-defined time intervals such as every one day or one hour. The aggregator 1314 may recalculate KPIs based on the aggregated component data, and updated KPIs may be sent to an analytics database 1316. Additionally, the aggregated component data and KPIs may be provided to the machine learning component 1310.

The machine learning component 1310 may further receive training data from a training data database 1318, which may provide various parameters, weightings, etc., to train the machine learning component 1310. From the component data, training data, and outputs from the rule engine 1304 and aggregator 1314, the machine learning component 1310 may assess if an anomaly has occurred for any of the components (1320). The anomaly may be used to determine a component status that has not violated a rule, but which may be a concern for application managers. The identification of anomalies may also be used to generate new rules by the machine learning component 1310. If an anomaly has been detected a notification may be sent to the notification engine 1308 and the results may be provided to the analytics database 1316.

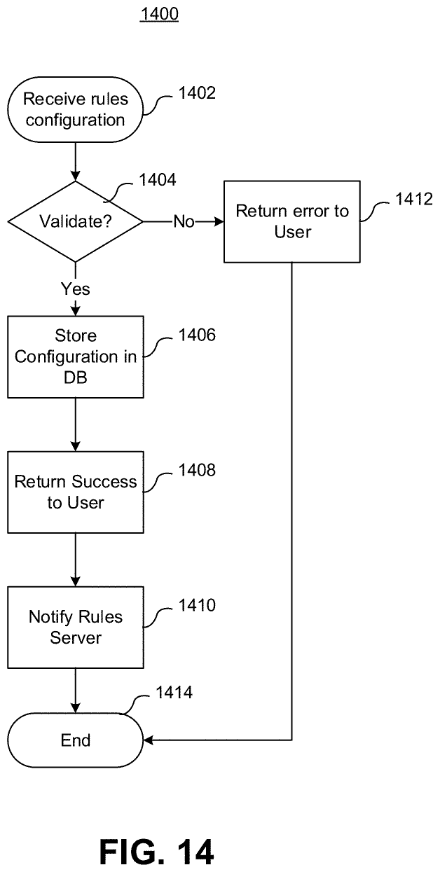

FIG. 14 depicts an analytics configuration server call flow (1400). A rules configuration server receives the rules configuration outlining the specific application rules the user has inputted (1402). A determination is made to see if the received rules configuration is valid (1404). If the rules configuration is determined to be valid (YES at 1404), the configuration server may store the configuration in an associated database, such as the analytics-rules configuration DB 1302 (1406). A notification indicating successful storage of the rules configuration is sent to the user (1408). A notification is sent to the rules server of the rules configuration (1410), and the method ends (1414). If the rules configuration is determined to be invalid (NO at 1404), an error may be returned to the user (1412), and the method ends (1414).

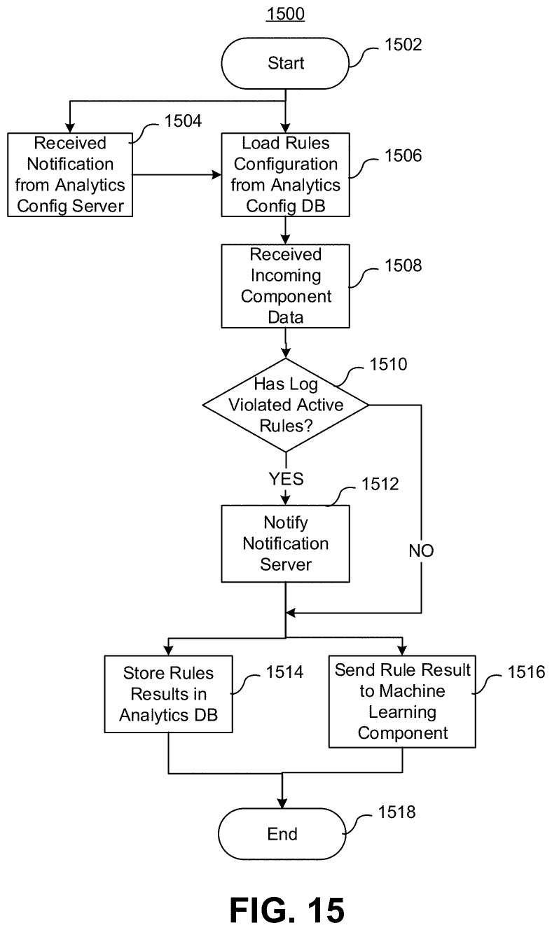

FIG. 15 depicts a rules server call flow (1500). The method starts (1502) by receiving notification from analytics configuration server (1504) of a new rule configuration and/or with loading the rules configuration from the analytics configuration database 1302 (1506). Logs and other component data are received at the rules server (1508). A determination is made to assess if the component data violates any of the active rules outlined in the rule configuration (1510). If the incoming logs violate any of the active rules (YES at 1510) a notification is sent to the notification server (1512), and the rules results are stored in analytics database (1514) as well as sent to machine learning component 1310 (1516). If the component data does not violate any of the active rules (NO at 1510) the rules results are still stored in analytics database (1514) as well as sent to machine learning component 1310 (1516), after which the method ends (1518).

Once the logs have been assessed, irrespective of the results, the rules results are stored in an associated analytics database (1514). In addition, the rule results are to be sent to the machine learning component (1516). If the incoming logs do not violate any of the active rules outlined, there is no notification sent to the notification server.

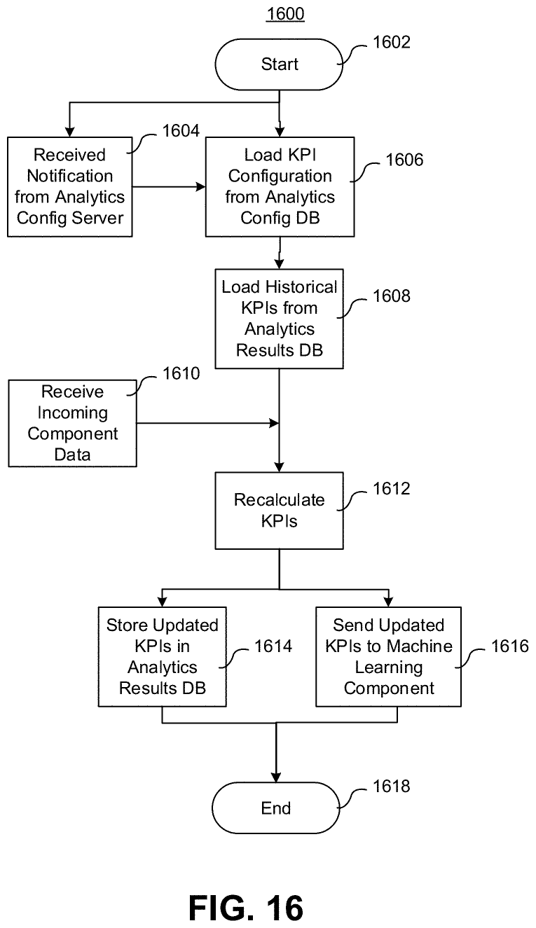

FIG. 16 depicts an aggregator call flow (1600). The method starts (1602) by receiving notification from analytics configuration server (1604) of a new aggregator configuration, such as new KPIs, and/or with loading the aggregator configuration from the analytics configuration database 1302 (1606). The historical KPI data is loaded from the analytics results database (1608). The component data such as logs, monitoring tests, and reports are received (1610). Using the historical KPI and the current component data, the KPIs can be recalculated (1612). The updated KPIs may be stored in the analytics results database (1614) and sent to the machine learning component (1616), and the method ends (1618).

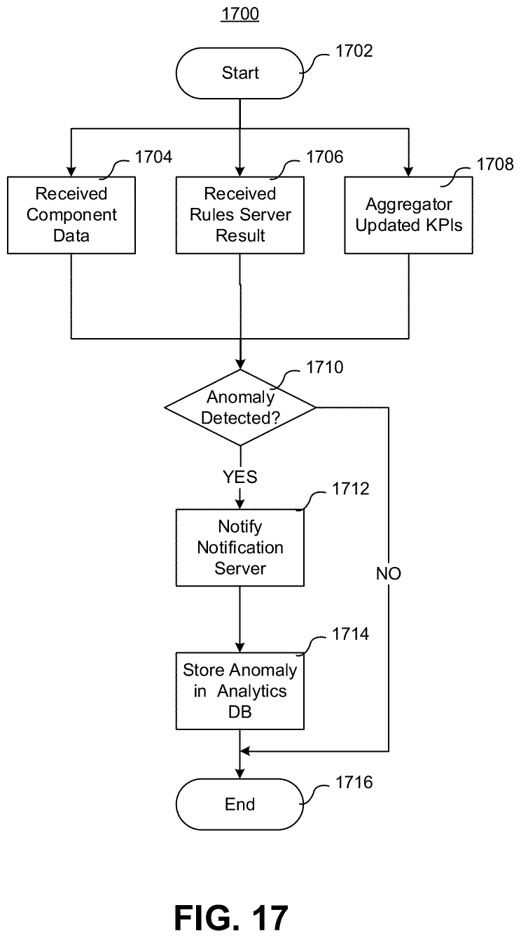

FIG. 17 depicts a machine learning call flow (1700). The method start (1702) by receiving one or more of component data (1704), rules server results (1706), and aggregator updated KPIs (1708). As previously described, training data may also be provided but is omitted in this example. A determination is made by the machine learning component if an anomaly has been detected (1710). If an anomaly has been detected (YES at 1710), a notification is sent to the notification server (1712). Upon notifying the notification server, the anomaly is stored in the analytics database 1316 (1714) and the method ends (1716). If an anomaly has not been detected (NO at 1710), the method ends (1716).

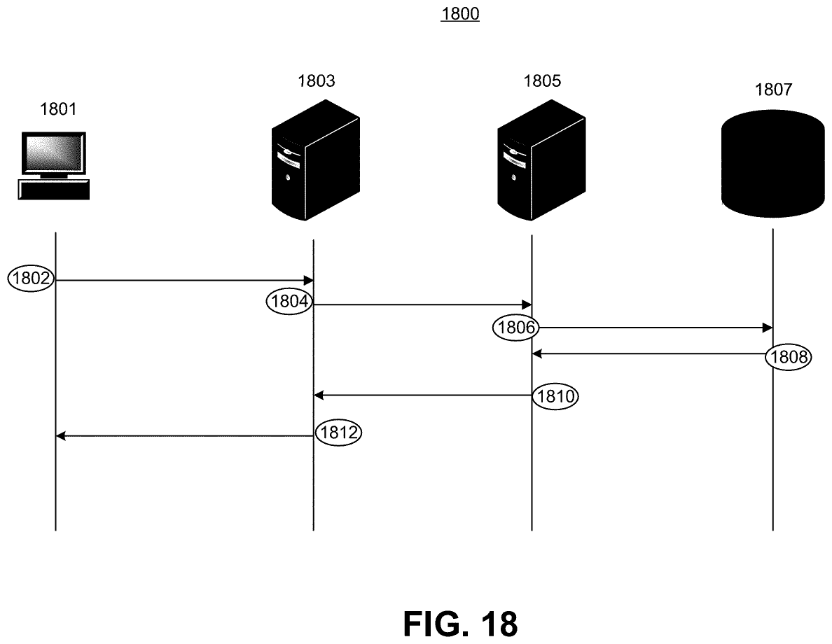

FIG. 18 depicts a reporting sequence diagram (1800). A user, such as an application manager 104, may log onto a dashboard/portal with valid credentials from a computer 1801. The user may request a report (1802), such as based on subscription parameters, monitoring test reports, logging reports, analytics reports, etc., from a reporting server 1803. The reporting server 1803 may query the appropriate subscription/monitoring/logging/analytics server 1805 requesting the respective report (1804). The respective subscription/monitoring/logging/analytics server 1805 may query a respective subscription/monitoring/logging/analytics database 1807 (1806) for the requested generated reports and/or relevant data, which is retrieved from the subscription/monitoring/logging/analytics database 1807 (1808). The subscription/monitoring/logging/analytics server 1805 provides the requested report to the reporting serer 1803 (1810), which is provided to the user (1812).

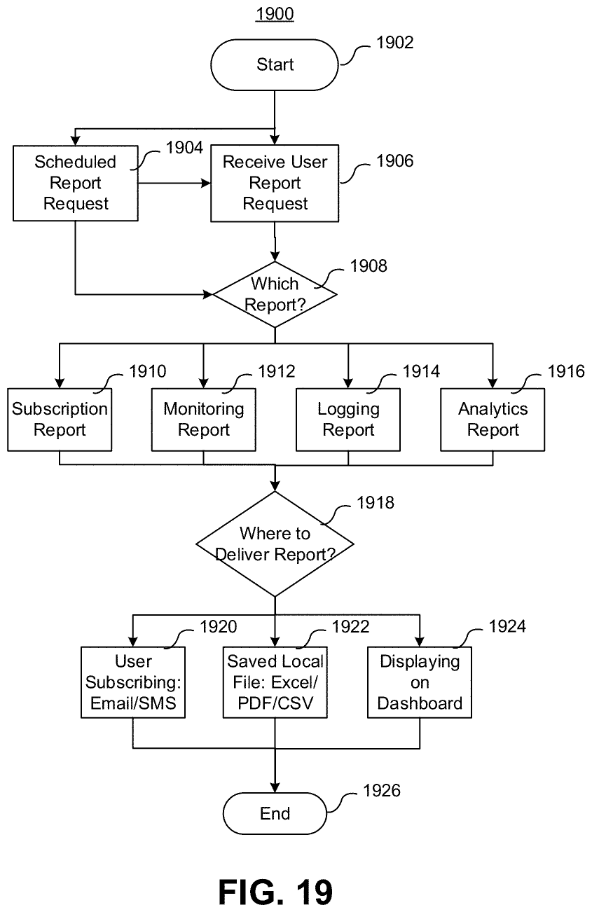

FIG. 19 depicts a reporting call flow (1900). The method 1900 starts (1902) in accordance with a scheduled report request (1904) and/or in response to a user report request (1906). The reporting server identifies which type of report (1908), which may for example be a subscriptions report (1910), monitored report (1912), logging report (1914), and/or analytics report (1916).

A determination is made on the method of delivery of the report (1918). The report delivery method may be established by the user, for example. The report may be provided to the user by Email/SMS (1920), saved as a local file (1922), or displayed on the dashboard (1924), for example, and the method ends (1926).

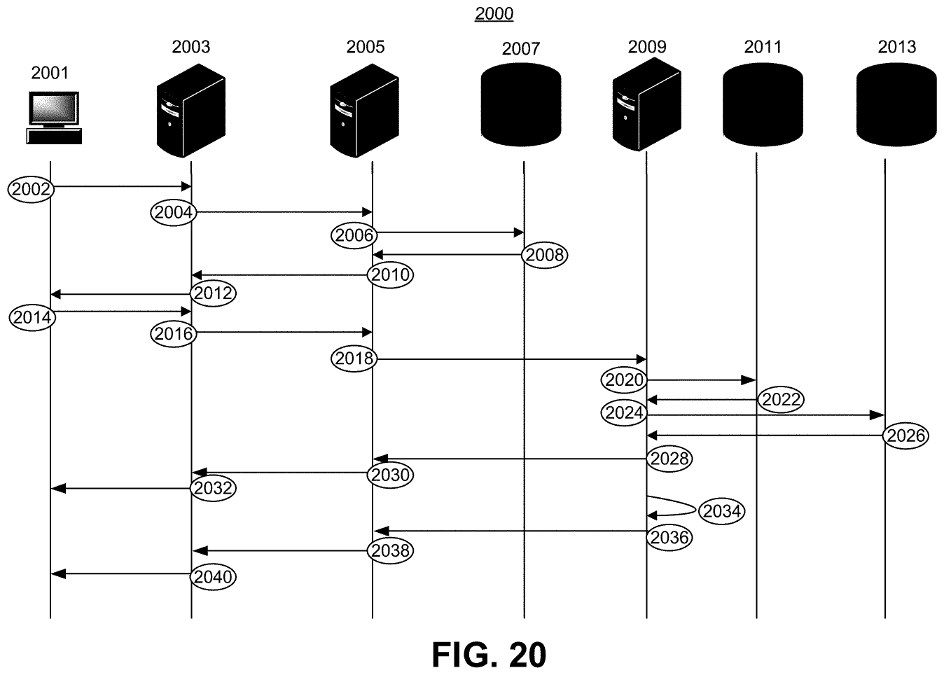

FIG. 20 depicts a dashboard sequence diagram (2000). A user, such as an application manager 104, may log onto the dashboard from a computer 2001 using login credentials such as single sign on. The login credentials are provided to a proxy server 2003 (2002), and the credentials are further provided to a web server 2005 (2004). The web server 2005 verifies the login credentials by accessing an active/services database 2007 (2006). When the login credentials have been verified a notification of success is sent from the active/services database 2007 to the web server 2005 (2008) and from the web server 2005 back to the proxy server 2003 (2010). The proxy server 2003 provides a notification back to the computer 2001 of successful login credentials (2012).

Where the user has subscribed to specific applications and requests access to these applications and corresponding reports, the user may request reports from the proxy server 2003 (2014). The proxy server 2003 forwards the report requests to the web server 2005 (2016). The web server 2005 sends the request to an application server 2009 (2018). The applications server 2009 may retrieve a subscription configuration as specified by the user from the configuration/subscription database 2011 (2020). Once the application server 2009 receives the subscription configuration from the configuration/subscription database 2011 (2022), report and events may be requested from a report event database 2013 (2024). The report/event is successfully received at the application server 2009 (2026) and is sent to the web server 2005 (2028) followed by the proxy server 2003 (2030). The user report is successfully returned to the user via computer 2001 (2032).

If a notification is received at the application server 2009 indicating an event (2034), such as the identification of the failed component, the user may be notified of the report/event provided to the web server 2005 (2036) followed by the proxy server 2003 (2038) and then the user computer 2001 (2040).

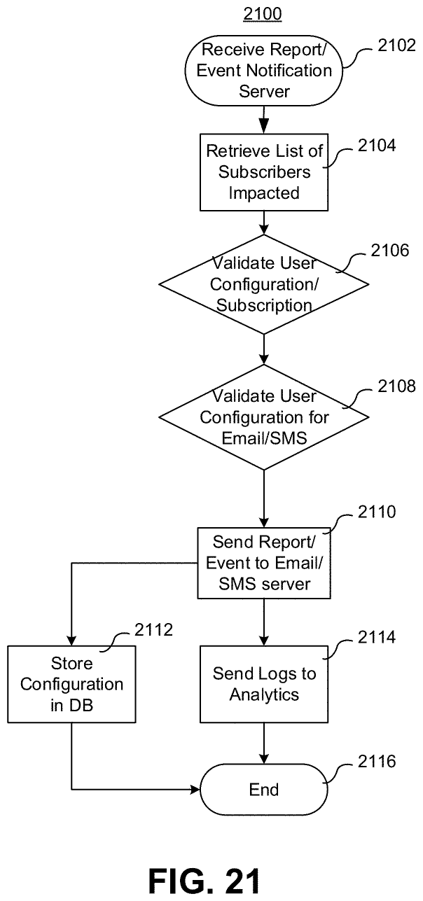

FIG. 21 depicts a dashboard application server call flow (2100). A notification is received from the Report/Event Notification server of an event (2102). A list of subscribed applications impacted by an event is acquired by an application server (2104). The user configurations and subscriptions may be validated (2106), and the users' configuration for Email/SMS may be validated (2108). Once validated, a report/event may be sent to an Email/SMS server (2110). The content of the report/event may be stored in a database (2112) and may be sent to analytics (2114), and the method ends (2116).

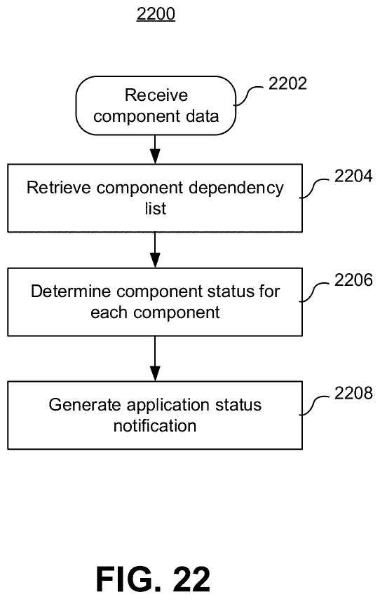

FIG. 22 depicts a method performed by the application health monitoring and reporting system. The method 2200 may be performed by the health monitoring server 108. The health monitoring server 108 may store computer-executable instructions in a memory, and when the computer-executable instructions are executed by a processor of the health monitoring server 108, the health monitoring server is configured to perform the method 2200. The method 2200 can be performed once the health monitoring server 108 has been instructed to monitor the health of an application. The method 2200 may be performed continuously, periodically, and/or based on user commands.

Component data is received (2202) for components associated with an application being monitored. As previously described, the component data may be received as incoming logs. The health monitoring server 108 may request the component data from the various components and in response receive the component data, or the components associated with the application may periodically send component data to the health monitoring server 108.

The component dependency list for the application is retrieved (2204). As previously described, the component dependency list may be manually configured in advance. Alternatively, the component dependency list may be determined by the health monitoring server. In either case, the component dependency list is retrieved from storage at or associated with the health monitoring server 108.

For each component in the component dependency list, a component status is determined (2206). The component status may be determined using the component data received at the health monitoring server 108. The component status may be determined by the application of one or more rules to determine if a rule has been violated.

The health monitoring server 108 may generate an application status notification (2208). The application status notification may be used for presenting to the user the health of the application. As previously described, the application status notification may not be transmitted to the application managers/stakeholders unless the application status notification comprises an application event that the stakeholders have subscribed to. The application status notification may be stored by the health monitoring server 108 for subsequent retrieval/access.

It would be appreciated by one of ordinary skill in the art that the system and components shown in FIGS. 1-22 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A method of health monitoring for an application, comprising:
receiving component data from a plurality of components associated with the application;
retrieving, from a database, a component dependency list indicative of dependencies of the plurality of components associated with the application;
determining a component status for each of the plurality of components in the component dependency list based on the received component data; and
generating an application status notification indicating the determined component statuses for one or more of the of the plurality of components in the component dependency list.

2. The method of claim 1, further comprising:
transmitting the application status notification to an application manager through a portal.

3. The method of claim 2, further comprising:
receiving subscription parameters from the application manager through the portal, the subscription parameters indicating one or more application events that the application manager has subscribed to; and
transmitting the application status notification to the application manager when the determined component statuses correspond to an application event of the one or more application events that the application manager has subscribed to.

4. The method of claim 1, further comprising:
transmitting the application status notification to a user of the application through the application.

5. The method of claim 4, wherein the application status notification comprises information allowing the user of the application to take a corrective action.

6. The method of claim 1, wherein the application status notification indicates a failed component of the plurality of components in the component dependency list, and the application status notification further indicates an estimated time to fix the failed component.

7. The method of claim 1, wherein each component of the plurality of components comprises a unique identifier that is used to identify the respective component.

8. The method of claim 7, wherein the component data is received as log data from the plurality of components, each log comprising the unique identifier for the respective component.

9. The method of claim 8, further comprising:
determining the component status from the component data based on whether a component state of the component has changed.

10. The method of claim 9, further comprising:
performing testing of one or more of the plurality of components.

11. The method of claim 1, further comprising:
applying pre-defined rules to the component data,
wherein a component status is determined to have failed if a rule has been violated.

12. The method of claim 11, further comprising:
transmitting the application status notification if a rule has been violated.

13. The method of claim 11, further comprising:
retrieving a KPI for the component data; and
determining that an anomaly has occurred based on the KPI when the component data did not violate a rule,
wherein the component status may be determined based on the anomaly.

14. The method of claim 1, wherein the component dependency list is defined manually by an application manager.

15. The method of claim 1, further comprising:
determining, from the received component data, the plurality of components associated with the application and their dependencies;
generating, based on the determined dependencies, the component dependency list; and
storing the component dependency list.

16. The method of claim 1, wherein the plurality of components comprise any one or more of: hardware components, software components, service components, and micro-service components.

17. A system for health monitoring for an application, comprising:
a processor; and
a memory operably coupled with the processor, the memory having computer-executable instructions stored thereon, which when executed by the processor configure the processor to:
receive component data from a plurality of components associated with the application;
retrieve, from a database, a component dependency list indicative of dependencies of the plurality of components associated with the application;
determine a component status for each of the plurality of components in the component dependency list based on the received component data; and
generate an application status notification indicating the determined component statuses for one or more of the of the plurality of components in the component dependency list.

18. A non-transitory computer-readable medium having computer-executable instructions stored thereon, which when executed by a computer configure the computer to perform a method comprising:
receiving component data from a plurality of components associated with the application;
retrieving, from a database, a component dependency list indicative of dependencies of the plurality of components associated with the application;
determining a component status for each of the plurality of components in the component dependency list based on the received component data; and
generating an application status notification indicating the determined component statuses for one or more of the of the plurality of components in the component dependency list.
